(19) United States
(12) Patent Application Publication
(10) Pub. No.: US 2005/0000024 A1
(43) Pub. Date: Jan. 6, 2005

(54) Inflatable and fully adjustable foot and seat support for travelers

(76) Inventor: Henryk P. Jakubowski, Forest Hills, NY (US)

Correspondence Address: HENRYK P. JAKUBOWSKI, 65-10 108th ST. APT. 5H, FOREST HILLS, NY, 11375, US

(21) Appl. No.: 10/613,880

(22) Filed: Jul. 3, 2003

(51) Int. Cl. B68G 5/00

(52) U.S. Cl. 5/655.3; 5/648

(57) ABSTRACT

“Inflatable and Fully Adjustable Foot and Seat Support for Travelers” will accommodate travelers with different leg characteristics: height, deformity, injuries. Bellows or accordion sidewalls will fully adjust shape, height or angulations of the foot rest. Velcro straps attached to the sides of a foot rest will configure the shape and retain its configuration even after deflation, for storage or transport. In addition Velcro straps will permit securing various attachments to feet or to the bag itself. Allowing comfortable and worry free use of the air pillow even during sleep or nap by securing the connection between feet and bag itself Lanyard attached to the bag itself or food tray will facilitate easier placement or removal of above-mentioned pillow on or from the floor. Bathtub design of the pillow will permit minimum amount of gas to fully inflate a foot rest to its full dimensions and its full function.

### CROSS-REFERENCE TO RELATED APPLICATIONS

| | | | |
|---|---|---|---|
| 6442779 | September 2002 | LeVert, et al. | 5/648 |
| 6292964 | September 2001 | Rose, et al. | 5/630 |
| 6256818 | July 2001 | Hughes | 5/639 |
| 6206475 | March 2001 | Tai | 297/452.41 |
| 6478380 | November 2002 | Ehrlich | 297/423.46 |
| 6175979 | January 2001 | Jackson | 5/648 |
| 6013042 | January 2000 | Sakai | 601/134 |
| 6012778 | January 2000 | Peterson | 297/452.41 |
| 6131219 | October 2000 | Roberts | 5/644 |
| 6,141,807 | November 2000 | Tapper | 5/653 |
| 6125486 | October 2000 | Rabon | 5/654 |
| 5975629 | November 1999 | Lorbiecki | 297/200 |
| 5868463 | February 1999 | Mackenzie, | 297/228 |
| | | et al. | |
| 5634223 | June 1997 | Obermajer | 5/654 |
| 5645319 | July 1997 | Parks, Jr. | 297/391 |
| 5628547 | May 1997 | Matsumiya | 297/354.11 |
| 5562324 | October 1996 | Massara | 297/284.6 |
| 5,497,520 | March 1996 | Kuntz, et al. | 5/648 |
| 5544378 | August 1996 | Chow | 5/644 |
| 5471690 | December 1995 | McNeil | 5/644 |
| 5330255 | July 1994 | Stawicki | 297/391 |
| 5120111 | June 1992 | Cook | 297/452.41 |
| 4914766 | April 1990 | Moore | 5/644 |

### STATEMENT OF FEDERALLY SPONSORED RESEARCH OR DEVELOPMENT

Not applicable

### BACGROUND OF THE INVENTION

The present invention relates to a of new kind of portable foot support for passengers, that is lightweight, compact, and fully adjustable both horizontally and vertically. The footrest is designed with the intent of providing positive foot support, and increased comfort for travelers on extended bus/train rides, and long flights. The symptoms of common traveler's ailments such as swelling of feet and /or ankles, cramping and the occurrence of deep vein thrombosis could be reduced by this device.

Traditional seat designs in the airplanes, buses, and trains typically do not include devices to provide adjustment for variation in height of the passengers. Restricted space and inability to stretch legs or walk on long flights causes interruption of normal blood circulation especially in lower extremities and contributes to formation of blood clots. According to British United Provident Association (BUPA), a British insurance company, passengers who have their feet dangling in the air are prone to restrict blood circulation in the legs because of compressed blood vessels in the thighs and calves and I quote: “Although anyone can develop DVT on a flight, certain people are more Vulnerable, including pregnant women, people who are overweight, those whose feet don't reach the floor (because the seat puts more pressure on the backs of their legs), the elderly, smokers and those with coronary artery diseases and certain blood conditions”—http://hcd2.bupa.co.uk/fact_sheets/mosby_factsheets/Deep_Vein_Thrombosis.html. Cramped and restricted spaces provide additional complication for tall passengers, causing cramps and aches not only in the muscles of the legs but also of the back and neck. Inflatable airbag with bellows (accordion) type sides (see FIG. 3), will facilitate adjustment to angle and height of the inflatable foot rest/gas pillow/air bag and will provide better and positive foot support (rest). Device will be placed on the floor, in front of passenger and lanyard attached to the foot rest (see FIG. 1 G), will facilitate placement or removal of the device from the floor.

Recent safety concerns for airline travelers prohibits passengers from carrying sources of compress gas in the cabin, therefore bathtub/torus design of the foot rest (see FIG. 2) offers advantage over simple flat bottom design, by utilizing minimum amount of the air needed to inflate the air pillow and achieve full deployment with all its functions. Placement of the air bag on the back of the seat will provide lumbar support (see FIG. 5), or on the seat itself (see FIG. 7), will provide relieve for the spine and will help in adjustment of seating position especially useful for taller than average passengers. Velcro type straps (see FIG. 8 and FIG. 9) attached to bag at points ABCD (see FIG. 1), will provide means to control the angles and height of the bag itself and which will permit fine tuning of the shape of the foot rest, this will provide perfect support for passengers of and height and size. In addition Velcro strap (see FIG. 9) will provide a secure bond between passenger's feet and air pillow (see FIG. 1 point E) which will prevent displacement of the air bag from under passengers legs especially during the sleep, or napping time in the journey. In addition Velcro straps (see FIG. 8 and FIG. 9) will secure placement of optional battery operated vibrators or chemical (flameless) heat source. This will help to stimulate blood flow and provide additional comfort in over air-conditioned environment of airplanes: According to Holistic-Online and I quote: “The oxygen capacity of the blood can increase 10-15% after massage. By indirectly or directly stimulating nerves that supply internal organs, blood vessels of these organs dilate and allow greater blood supply to them. Massage increases the circulation of blood and flow of lymph. The direct mechanical effect of rhythmically applied manual pressure and movement used in massage can dramatically increase the rate of blood flow. Also, the stimulation of nerve receptors causes the blood vessels (by reflex action) to dilate, which also facilitates blood flow? This has a profound effect on one's health”. http://www.holistic-online.com/massage/mas_and-health.htm”,

According to The National Institute on Aging, NIH, U.S. Department of Health and Human Services and I quote: “Here are eight ways to keep your blood moving and your feet happy: Have a gentle foot massage. Take a warm footbath, Try not to expose your feet to cold temperatures. Don't sit for long periods of time (especially with your legs crossed)”

Consequently attaching a vibrating element or heating container will enhance a traveler's sense of comfort. This can be accomplished with the use of a novel Velcro strap design, which incorporates a innovative longitudinal slit through most of the length of the strap (see FIG. 9) and/or L shaped design at the longer end of the of the strap (see FIG. 9 part a). By looping part a of the L shaped strap (see FIG. 9), around the appliance and part b of the strap around foot of the passenger and then touching the whole assembly to the grabbing part of the Velcro strap at point E on the air bag (see FIG. 1) passenger can achieve positive and stable connection between the foot and the inflatable footrest for as long as needed .With attachment of Velcro strap to a foot, passenger need not to worry about the possibility of displacing and loosing contact with foot support. The L shape design (see FIG. 9 part a) of the Velcro strap will provide a more stabile and secure connection of above mentioned appliances to the foot, by having a wider and more stable attachment to the foot. One of the contributing factors to passenger perception of comfort is ability to remove shoes while in flight, thus passengers wearing socks or bare feet will be able to fully utilize the heating and/or vibrating properties of various attachments to enhance the sense of comfort. Velcro straps will secure the placement of these additional appliances. Velcro straps will permit use of inflatable bag to be fully deployed with varied firmness or softness as well as lateral and horizontal adjustment to the air bag. This will further contribute to a passenger's sense of relaxation by providing full support for the legs, even for handicapped passengers, and/or those with injured or deformed feet by permitting a more comfortable placement of the passenger's feet on the bag itself (see FIG. 6)

The deployment of either strap (see FIGS. 8 & 9) could be also determined by users preference.

Widely reported incidents of health complications that included reports of death, as a result of long flight and my personal experience of swollen legs and burning sensation of feet during flight contributed to this invention.

### DESCRIPTION OF PRIOR ART

There are several designs for inflatable leg and foot supports in prior art which were designed to aid in the treatment of peoples with various diseases or as a part of a post operative treatment. For example U.S. Pat. No. 5,497,520 (Kunz) entitled “Inflatable Leg and Foot Support” describes use of an accordion-like construction of side panels of an inflatable airbag. The purpose of this configuration is in aiding deflation of the foot rest or for easier storage under the bed when not in use, or transport and I quote: “The side panels fold inwardly toward one another in accordion-like fashion to permit essentially full collapse of the foot and leg support to a thickness of only that of the combined thickness of rubber material, of which the support is constructed.” Present invention utilizes the accordion-like construction of the foot rest for full control of the shape of the air bag, by permitting changing of angles and height of the air bag in order to provide the optimal support for the passenger's feet. The accordion-like construction in this invention is not an aid in collapsing the device. as in previous invention. All these changes in configurations are obtained by lengthening or shortening the Velcro straps, and not by amount of the gas (air) pumped in to a foot rest. Varying angles, at which passenger can support feet during journey, will greatly relieve pressure on the calves and tendons for the duration of travel and will contribute to feeling of comfort and relaxation.

Firmness of the foot rest is not the most important feature of the foot support, because a vehicle's seat, and not amount of the air in the foot rest supports the weight of the passenger. Softness of the foot rest in the current invention is advantageous for passengers with injuries or structural defects of the feet, because it will permit better and more comfortable placement of the feet on the surface of the bag. Softer inflation of the device will also better accommodate passengers with one leg shorter than other. The longer leg will be placed deeper in the surface of the air pillow, shifting air to other side of the device, resulting in an elevated and firmer surface for better support for the shorter leg.

U.S. Pat. No. 4,914,766 (Moore) entitled: “Contourable Pneumatic Cushion” describes multiple cell cushion device to adapt itself to the contour of body. Present invention is one cell device that permits, the changing angulations (contour) of the foot rest via manipulation of Velcro straps and is not necessarily designed for full adaptation to a body shape, or to shape of the feet, but rather to provide a support platform for the feet.

U.S. Pat. No. 6,478,380 (Ehrlich) entitled “Portable Leg and Foot Form Rest” addresses the concerns of passengers by constructing rather cumbersome design without any possibility for individual adjustment. Present invention while simple in design (two flat surfaces) permits not only adjustments to the height of the footrests, but also permits changing of the angles of above mentioned foot rest surface, by adjusting Velcro straps. These adjustments will provide a more comfortable resting surface by also permitting softer resting areas for the feet, because the shape of the design is not determined by firm inflation of entire device.

U.S. Pat. No. 5,120,111 (Cook) entitled “Inflatable Seat” stresses the ease of transportation due to design of the device as a seat which can inflate and deflate for storage and transportation purposes. In Cook's invention straps are used primarily to compact the seat for transportation or to attach the inflatable seat to another structure. Strap in the present invention are not intended as a folding or deflating mechanisms, nor are straps meant as a fastening device, but instead present invention uses straps as a means to control the configuration, the shape and angulation of the foot rest in addition to setting the preferred height of the foot rest itself.

U.S. Pat. No. 6,292,964 (Rose) entitled: “Inclined Support Pillow” describes use of Velcro straps as a fastening device, unlike the present invention, that uses Velcro straps for variety of purposes.

U.S. Pat. No. 5,544,378 (Chow) entitled “Inflatable Pillow” intended for head support mentions the use of straps as a means to secure the pillow to the back of the seat, and I quote “A strap means is provided to secure the pillow to a back rest to provide stability of the pillow when in use and . . . trapezoidal section containing a relatively flat portion at its upper end and an inflatable portion at its lower end”. Chow's inventions utilizes trapezoidal shape in the intermediate section as a support for the neck, and it is not changeable or inflatable.” Present invention permits manipulation of the shape of an air bag, not necessarily creating a trapezoidal shape, by adjusting the length (lengthening or shortening) of the Velcro straps instead of using straps as a fastening device.

U.S. Pat. No. 5,645,319 (Parks, Jr) entitled: “Passenger's pillow” describes inflatable pillow of fix shape designed to support passenger's head when placed on folding tray table in front of the passenger, and I quote “The pillow's shape, once inflated, is predetermined to substantially occupy the space in front of such passengers”. Inflatable feature of Park's air pillow is a means for easier storage during the transport. Current invention's shape is not fixed and also uses firmness or lack of it as an additional means in achieving passenger's comfort, especially for those with some handicaps or injuries.

U.S. Pat. No. 5,330,255 (Stawicki) entitled: “Seat Integrated Inflatable Neck Support” describes Velcro fasteners as a means to attach neck support to the crown of a seat. Present invention utilizes Velcro straps to control the shape and profile of inflatable air cushion, and also for final adjustment to the most comfortable configuration.

U.S. Pat. No. 6,175,979 (Jackson) entitled “Inflatable Orthopedic Pillow” describes fix shape inflatable pillow designed not for travel, but for ambulatory use.

U.S. Pat. No. 6,141,807 (Tapper) entitled: “Adjustable height pillow and related furniture” describes use of encircling belt to I quote “cinch and constrict the medial portion of the pillow by reducing its circumference, thereby causing the filler material to move from medial portion to respective upper and lover portion of the pillow thus increasing the height of said pillow” Tapper's device does not address the changing of the angulations of the resting surface and has limited height control while decreasing the stability of resting surface in higher configuration. Present invention utilizes an innovative straps' design and accordion-like construction. for all adjustments.

U.S. Pat. No. 6,131,219 (Roberts) entitled: “Inflatable Pillow”, U.S. Pat. No. 5,868,463 (McKenzie) entitled: “Seat Cushion with Selectively Inflatable Interior seat and Back Compartments” uses additional gas chambers to change the shape of the pillow, making the design and production of the bag more complicated. Present invention utilizes innovative straps' design and accordion-like construction to change its shape

U.S. Pat. No. 6,442,779 (LeVert) entitled: “Portable feet elevator” does not permit changing of geometry (angulations) of the foot rest to permit passenger full adjustment of the appliance, only height of the foot rest is addressed, and shape of the bag is fixed. Utilizing prizmatoid-shaped design and does not employ accordion type design.

U.S. Pat. No. 6,013,042 (Sakai) entitled “Massaging device for feet and legs” describes the device constructed, and I quote “number of bosses each having a spherically headed portion on the top and lined on platform of certain height in plural rows” composed of rolling balls. While present invention utilizes a separate massaging appliance, which is electrically operated and/or flameless heat source that is not a integral part of the air cushion. The additional massaging appliance is designed to be utilized in three separate ways:

1. by attaching above mentioned appliance and/or heat source directly to the feet ,or foot of the user, using above described Velcro straps (see claim three FIG. 3) in order to directly stimulate to some degree blood circulation independent of the inflatable bag itself. This will also permit the user to move his or her legs around, to stretch or cross the legs and so on.

2. by attaching the massaging appliance and/or heat source to the bag itself and receive massage while obtain full benefit of resting the legs on above mentioned air bag.

3. Velcro strap is attached directly to the leg or bag, and is connected firmly to the bag itself User will obtain fill benefit of rest and massage even while sleeping without worry about loosing contact with the bag or appliance itself.

U.S. Pat. No. 6,206,475 (Tai) entitled “Inflatable cushion with a Vibration-Massage Device” describes appliance built in to the inflatable cushion with wires for power supply integrally attached to the cushion, and used primarily while seating on it. Present invention uses attachable vibrating devices or heating packets for use even without contact with inflatable cushion, thus permitting changing of seating position or moving legs around and not necessarily seating or resting on it. Furthermore design of the Velcro strap adapted primarily for manipulating the shape of the foot rest will contribute to easy connection of above mentioned air pillow to the legs of passenger, and will also facilitate in attaching of vibrating devices or heating pads to the passenger's feet or air pillow. Although the flameless heat source is not integral part of the foot rest, it will contribute to passengers comfort in an overly air-conditioned interior on an airplane. Usage of a flameless heat source might also prevent to some degree the constriction of the blood vessels in passenger's lower extremities caused by the cold surrounding, and might improve blood circulation_Additional usage of a vibrating appliance may also promote better circulation in the lower extremities.

U.S. Pat. No. 6,256,818 (Hughes) entitled: “heated massage pillow,” describes built in heating and massaging appliance inside in conventional foam pillow, without provisions of utilizing massaging and heating the features outside the pillow. Present invention permits self-contained appliances to be directly applied to passenger's feet while not a part of inflatable foot rest itself.

U.S. Pat. No. 5,634,223 (Obermaier) entitled: “Hollow Body for Use as Seat Pad” describes donut or toroid shape incorporated into the design of the seating pad for purpose of, and I quote “for preventing slipping of a person seated on said sitting region” Present invention uses bathtub design (donut, toroid) for limiting amount of the gas in the air pillow, in order to make inflation of the bag easier. This feature is especially convenient because current federal safety regulations prohibit the use or possession of compressed air (gas) sources or aerosols in the cabin of the airplane which otherwise might be used to inflate the footrest. Whether inflating the foot support using a manual pump or inflating the foot rest by mouth, this design will greatly contribute to ease of use of “Inflatable and Fully Adjustable Foot, and Seat Support for Travelers”. In addition present invention uses bathtub design as a means to achieve full function of an foot rest with minimum amount of a gas to inflate it, and still obtain full function capabilities and desired shape. Present invention however does not address the design of inflation method. Most likely the inflation tube with the stopper will be incorporated into the design

U.S. Pat. No. 6,125,486 (Rabon) entitled: “Seat for Treating Prostatitis” uses donut design for reducing the occurrence of and providing relief from prostatitis, and I quote “In particular, the adaptation of the seat in rough-riding vehicle would reduce perineal trauma. . . . The user sits in the tube and as a result pressure to the perineum is avoided and pressure is supported by the legs, hip or rear area.” Present invention uses this design as a means of limiting amount of the air needed to achieve the full use of an foot rest with all its benefits, and versatility of its function.

U.S. Pat. No. 5,471,690 (McNeil) entitled: “Travel Pillow” also uses torus design but primarily to prevent slippage of a travel pillow from the seat on which it is placed, and is intended to use as a head rest and helps to keep the head of the passenger on the pillow.

U.S. Pat. No. 5,562,324 (Massara) entitled “Lumbar Support Actuation” describes multi cell design and multi surface with flexible plate and seat frame. Current invention provides fully adjustable one cell design. There is no mention of torus shape for purpose of limiting amount of air needed to fully inflate the device. Lumbar support is achieved by shortening one pair of the Velcro straps while leaving other untouched.

### BRIEF SUMMARY OF INVENTION

Prior inventions in the field of supplemental support and comfort during travel, especially long flights in cramped and confined spaces lacked simplicity and versatility of its design. Present invention corrects all previous shortcomings in the field. Despite simplicity of design, present invention solves all previous problems: it customizes the shape, height and firmness to meet desired requirements of its user. Versatility of its design could be especially useful for short people, persons with handicaps, injured legs or feet. It simplifies placement of the device on desired spot on the floor or its retrieval. It ensures correct fit and provides secure connection between the feet of the users and footrest and ease of release from the support. The invention could be used optionally as a seat booster for especially tall users. This will help to improve posture and relax various groups of muscles in the legs, while contracting others, thus providing an additional form of comfort. This could additionally stimulate blood circulation.

### BRIEF DESCRIPTION OF THE DRAWINGS

For the purpose of clarity of design not all illustrations are drawn with the same scale.

FIG. 1 shows top view of a foot rest with Velcro straps attachment points A, B, C, D, E and G placed by a user at typical points on the upper surface of a foot rest. a, b, c, d, e, f shows points for the cross section axis of illustrations. G represents possible attachment point for lanyard.

FIG. 2 shows bottom view of a foot rest, showing bathtub design F and Velcro attachment points A, B, C, D, at the bottom surface.

FIG. 3 shows cross section view at the a, b axis showing bathtub design F with accordion walls H

FIG. 4 shows diagram of cross section at c, d, axis showing placement of adjustable Velcro straps (see FIG. 8 or FIG. 9), placed at points A and C, on the surfaces of an air pillow and going over accordion sides for typical and (natural) support of both feet.

FIG. 5 shows diagram of cross section at c, d, axis showing placement of adjustable Velcro straps (see FIG. 8 or FIG. 9), of equal lengths and placed at points A and C, on the surfaces of an air pillow and going over accordion sides for lumbar support configuration.

FIG. 5a shows possible lanyard placement point G on the top surface of an air pillow

FIG. 6 shows diagram of cross section at e, f, axis showing placement of Velcro straps (see FIG. 8 or FIG. 9) at points C and D, on the surfaces of an air pillow and going over accordion walls for the people with deferent length of the legs

FIG. 7 shows diagram of cross section at e, f, axis showing placement of Velcro straps (see FIG. 8 or FIG. 9) of equal length at C, D, points on the surfaces of an air pillow in seating configuration to be placed on the seat of the air plane or bus.

FIG. 8 shows top view of a Velcro strap with longitudinal slit separating it into two parts a and b

FIG. 9 shows top view of a Velcro strap with L shaped, better adapted for more stable attachment to passenger foot and air pillow

FIG. 10 shows diagram of cross section at a, b, axis showing placement of adjustable Velcro straps (see FIG. 8 or FIG. 9), on the top surface of an air pillow at the point E (see FIG. 1) for attachment of optional heating or vibrating appliances I to be left unattached to the feet of the passengers.

FIG. 11 shows diagram of cross section at a, b, axis showing placement of adjustable Velcro straps (see FIG. 8 or FIG. 9), on the top surface of an air pillow at the point E FIG. 1 for attachment of optional heating or vibrating appliances I to be left unattached to the feet of the passengers. and looped to support passenger's feet.

FIG. 12 shows diagram of cross section at a, b, axis showing placement of adjustable Velcro straps (see FIG. 8 or FIG. 9), on the top surface of an air pillow at the point E (see FIG. 1) to be left unattached to the feet of the passengers. .

FIG. 13 shows economy embodiment of the invention with two flat panels one on the top and other on the bottom, instead bathtub design

### DETAILED DESCRIPTION OF THE PREFFERRED EMBODIMENTS

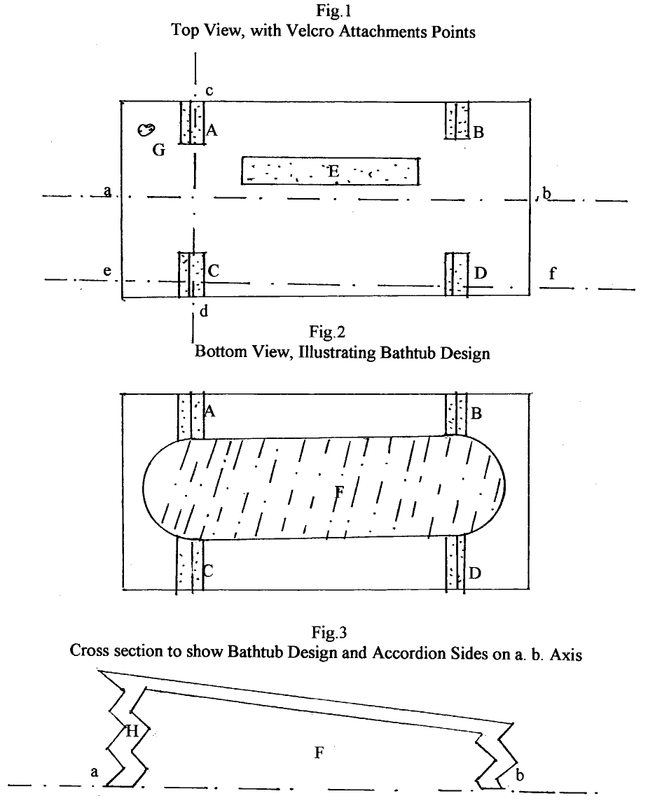

As seen in FIG. 1 “Inflatable and Fully Adjustable Foot and Seat Support” offers innovative use of Velcro straps and can be manufactured in conjunction with any other impregnable material, such as plastic or rubber.

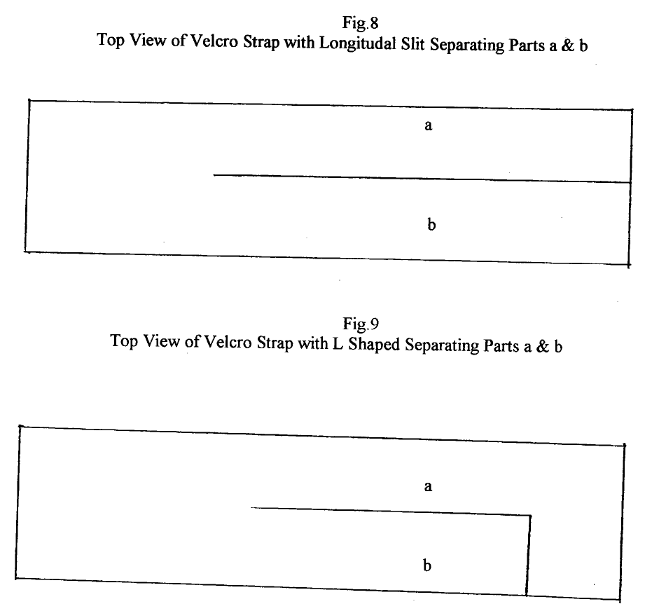

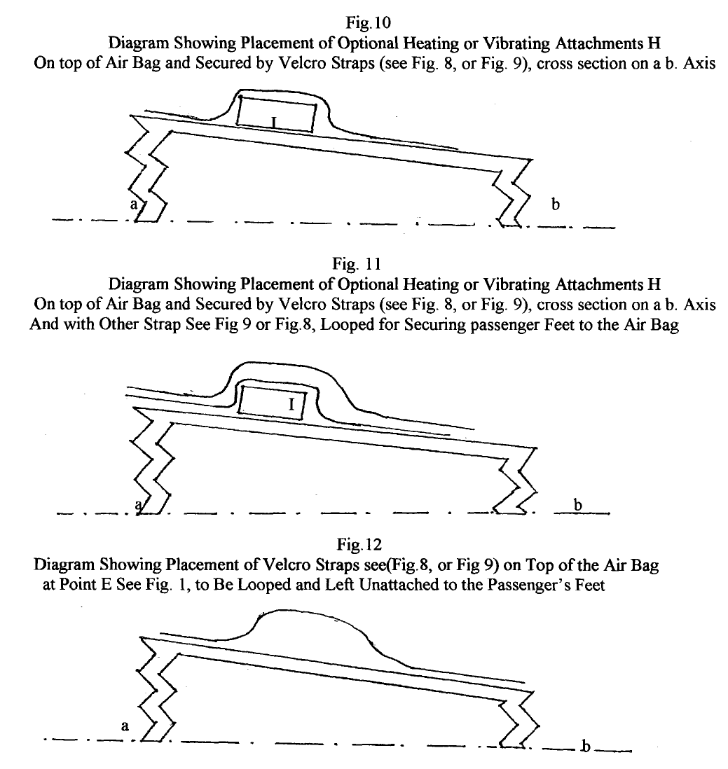

FIG. 1 shows the top view of “Inflatable and Fully Adjustable Foot and Seat Support for the Travelers”, with Velcro grabbing parts A.B.C.D.E. attached to its surface. Above-mentioned attachment points are also basis for the innovation. Until now there was no attempt to provide full adjustment of height and angulations of inflatable travel pillow. Velcro straps (see FIG. 8 and FIG. 9) permits full adaptation of the device to specific requirement and preferences of the each individual traveler. By having accordion sides (see FIG. 3) user will be able to adjust the height and angles of the air pillow to his or her preferences by shortening or lengthening all or some of above-mentioned Velcro straps. By keeping all the straps A, B, C, D, at equal length (see FIG. 7) height of the foot rest could be adjusted. While air pillow support is designed primarily as a foot support, it could be used in this configuration as a seating device. This use will greatly benefit tall passengers, by relieving muscle tension or changing posture when sitting intermittingly on it, or for heavyset people, by cushioning or reliving muscle compression.

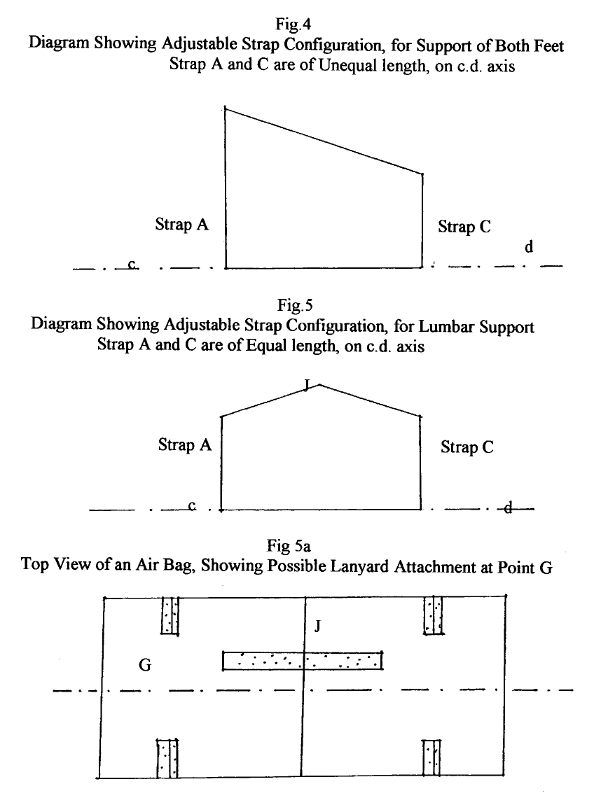

FIG. 4 shows the way angle of the foot support could be adjusted by shortening straps C and D, for better support of the feet or more comfortable seating.

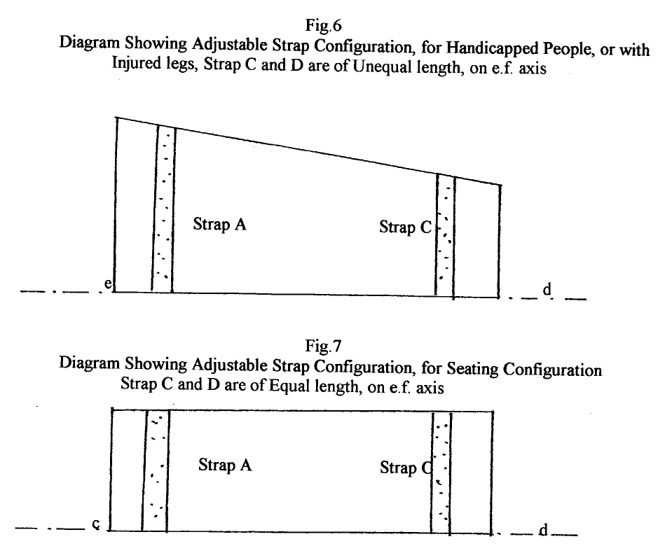

Lateral adjustment (see FIG. 6) will permit peoples with one leg shorter than other full support of both feet, and softer inflation afforded by use of the straps, will help people with deformed or injured feet better support and comfort.

FIG. 5 shows another embodiment of the air pillow as a lumbar support by having crease J made on the top of the bag (see FIG. 5a), and straps A, B, C, D, shortened and pillow placed on the back of the seat. Once adjusted to desired length Velcro straps will retain its position even after repeated deflation or inflation of the foot rest after each use or trip. Bathtub constructions F (see FIG. 2 and FIG. 3) is designed to minimize amount of the air needed to inflate the travel pillow to desired dimensions and shape. This feature is especially important in the light of current safety restrictions for use of compressed air sources aboard the airplane by passengers in the cabin. Manual pumps or inflation by mouth will be less strenuous with bathtub design and will take less time to achieve its full inflation.

Innovative Velcro straps (see FIG. 8 and FIG. 9), will permit not only different configuration of the air pillow itself, but will expand the comfort in use of the bag. Attaching the straps to the user's feet will permit the securing of optional appliances such as vibrators or flameless heating pads directly to the passenger's feet. This will enhance comfort during travel. In addition it might possibly stimulate blood circulation. Many passengers remove their shoes during long flights, therefore using a heating device secured to the feet will keep them warm in the over air-conditioned passenger cabin. This could be accomplished by looping and fastening part a of the strap (see FIG. 9) around the attachment and fastening and looping part b. around the foot to desired comfort. Modification of the strap (see FIG. 8 and/or FIG. 9) will be better suitable as a means of attaching the vibrator or a heating pack to the feet and provide better stability for the attachments. Touching this assembly to the point E. on the top of the bag (see FIG. 1) by user will secure positive foot connection to the foot rest for desired period of time. Disengagement will be achieved by pulling one foot out, while holding the bag to the floor with the other foot. Straps could be worn on both feet if desired.

Diagrams: FIGS. 4, 5, 6 and 7 illustrates the principle how the straps affect the configuration of the foot rest itself.

Attaching above-mentioned Velcro strap to the bag itself (see FIG. 1 at point E) passenger will be able to sleep, or take short nap without worry of loosing contact with the foot rest. Lanyard attached at point G (see FIG. 1) will permit the user easy placement of the foot support on desired spot on the floor, its removal from the floor if desired, or in placing the air pillow on the seat itself. Attaching the lanyard to the folding tray in front of the passenger or to the seat itself will permit easy location of the foot rest during or after use. Placement of the lanyard on the surface of the air pillow could be accommodated by using Velcro strips, snap on, or any other means. Using Velcro straps provides for another advantage by placing them on any part of the surface of the foot rest, or omitting their use to suite individual needs of any passenger or user.

While several embodiments of present invention have been shown and described, it is to be understood that many changes and modifications may be made thereunto without departing from the spirit and scope of the invention as defined in the appended claims.

### IN OTHER EMBODIMENT

FIG. 10 shows optional appliance I attached to the foot rest by Velcro strap (see FIG. 8, or FIG. 9) alone, in order to permit free movement of legs over whole surface of air pillow FIG. 11 shows looping of the Velcro strap, (see FIG. 8 or 9) over the appliance I and left alone on the surface of a foot rest in order to permit easy placement or removal of the legs on the surface of the air pillow during the time of high passenger's activity . . .

FIG. 12 shows looping of Velcro strap see FIG. 8 or 9, without optional attachment on the surface of the air pillow in order to permit easy placement or removal of the legs on the surface of the air pillow during the period of high passenger's activity. Utilizing Velcro as a preferred means of attachments will permit flexible placement points on any area on the surface of the air pillow, to suite individual requirement of any user.

### IN ANOTHER EMBODIMENT

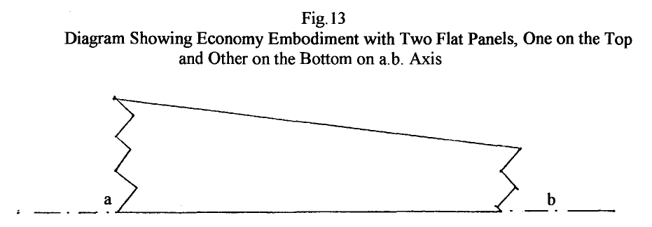

FIG. 13 show the economy embodiment of the air pillow, where bathtub design is eliminated and instead two flat surfaces are employed. This construction is used in the instances there is not a proscription on using compressed source of gas e.g. on the buses or on trains or when the price of the appliance is the factor. In this instance Velcro straps could also be purchased separately.

1. An inflatable gas pillow of any size comprising:
accordion type sidewalls
Velcro straps
bathtub design
lanyard

2. An inflatable gas pillow set forth in claim 1 wherein accordion type sides will provide for adjustable height.

3. An inflatable gas pillow set according to claim 1 wherein accordion sides will support adjustable seating surface.

4. An inflatable gas pillow set forth in claim 1 wherein Velcro straps will adjust height of the bag.

5. An inflatable gas pillow set forth in claim 1 wherein Velcro straps will adjust the angels of the bag.

6. An inflatable gas pillow set forth in claim 1 wherein Velcro straps attached to the foot rest will control the shape, firmness and the profile if the bag.

7. An inflatable gas pillow set according to claim 1 wherein varying the length of Velcro strap will permit changing the size of the bag.

8. An inflatable gas pillow set according to claim 1 wherein varying the length of the Velcro straps will change configuration of the bag.

9. An inflatable gas pillow set according to claim 1 wherein employed Velcro straps will retain bag's shape even after multi inflation and deflation cycles.

10. An inflatable gas pillow set according to claim 1 wherein Velcro strap is configured to have longitudinal slit through most of the length of the strap

11. An inflatable gas pillow set according to claim 1 wherein Velcro strap having longitudinal slit through most of the length of the strap will permit approximate adjustment of a foot rest shape by employing one part of the strap.

12. An inflatable gas pillow set according to claim 1 wherein Velcro strap having longitudinal slit through most of the length of the strap will permit fine adjustment for the foot rest configuration using other part of the strap without loosing previous configuration.

13. An inflatable gas pillow set forth in claim 1 wherein Velcro strap with slit in the middle will accommodate passenger foot.

14. An inflatable gas pillow set forth in claim 1 wherein Velcro strap with slit in the middle will accommodate various attachments.

15. An inflatable gas pillow set forth in claim 1 wherein Velcro strap with slit in the middle will connect foot to the foot rest.

16. An inflatable gas pillow set forth in claim 1 wherein Velcro strap with slit in the middle will be left attached to the gas pillow with various attachments in order to simplify the removal the feet from the gas bag

17. An inflatable gas pillow set forth in claim 1 wherein Velcro strap with slit in the middle will be left attached to the gas pillow and form the loop for easer placement or removal of the feet from the gas bag

18. An inflatable gas pillow set according to claim 1 wherein bathtub design will minimizes amount of the air needed to fully inflate the pillow.

19. An inflatable gas pillow set according to claim 1 wherein lanyard attached to air pillow will permit placement of the foot rest on desired spot on the floor

20. An inflatable gas pillow set according to claim 1 wherein lanyard attached to foot rest will permit easy retrieval from the floor

21. An inflatable gas pillow set according to claim 1 wherein lanyard will be attached to the folding tray in front of the seat for easy retrieval of the foot rest.

22. An inflatable gas pillow set forth in claim 1 wherein Bathtub, donut or torus design will limit the amount of the gas in the foot rest needed to provide full function of the device. This feature is especially useful for air travelers because federal safety regulations restrict the use of the compressed air dispensers in the cabin of the airplane.

23. An inflatable gas pillow set forth in claim 1 wherein bathtub design will be eliminated in economy configuration and still retain most of the features
